(19) United States
(12) Patent Application Publication
(10) Pub. No.: US 2025/0083966 A1
(43) Pub. Date: Mar. 13, 2025

(54) CONVERSION OF CO2 AND H2 TO SYNGAS

(71) Applicant: Topsoe A/S, Kgs. Lyngby (DK)

(72) Inventor: Peter Mølgaard MORTENSEN, Kgs. Lyngby (DK)

(73) Assignee: Topsoe A/S, Kgs. Lyngby (DK)

(21) Appl. No.: 18/727,613

(22) PCT Filed: Jan. 23, 2023
(86) PCT No.: PCT/EP2023/051560

§ 371 Date: Jul. 9, 2024

(30) Foreign Application Priority Data
Jan. 24, 2022 (EP) 22152991.0

(51) Int. Cl. C01B 32/40; B01D 53/00; C01B 5/00

(52) U.S. Cl. CPC C01B 32/40; B01D 53/002; C01B 5/00; B01D 2256/16; B01D 2256/20; B01D 2257/504

(57) ABSTRACT

A plant including a reverse water gas shift (RWGS) section including a first feed including hydrogen to the RWGS section, and a second feed including carbon dioxide to the RWGS section, or a combined feed comprising hydrogen and carbon dioxide to the e-RWGS section, a water removal section downstream the RWGS section, a compressor downstream the water removal section, and a cryogenic CO2 separation section downstream the compressor, wherein the plant has means for recycling at least a portion of a CO2 rich condensate to the RWGS section or to a feed to the RWGS section, and wherein the RWGS section is an electrically heated RWGS (e-RWGS) section.

### TECHNICAL FIELD

The present invention relates to a syngas producing plant with effective use of various streams, in particular carbon dioxide. A method for producing a syngas stream is also provided. The plant and method of the present invention provide overall better utilization of carbon dioxide.

### BACKGROUND

Carbon capture and utilization (CCU) has gained more relevance in the light of the rise of atmospheric CO₂ since the Industrial Revolution. In one way of utilizing CO₂, CO₂ and H₂ can be converted to synthesis gas (a gas rich in CO and H₂) which can be converted further to valuable products like alcohols (including methanol), fuels (such as gasoline, jet fuel, kerosene and/or diesel produced for example by the Fischer-Tropsch (F-T) process), and/or olefins etc.

Existing technologies focus primarily on stand-alone reverse Water Gas Shift (RWGS) processes to convert CO₂ and H₂ to synthesis gas. The synthesis gas can subsequently be converted to valuable products in the downstream processes as outlined above. The reverse water gas shift reaction proceeds according to the following reaction:

CO₂(g)+H₂(g)↔CO(g)+H₂O(g) (1)

The RWGS reaction (1) is an endothermic process which requires significant energy input for the desired conversion. High temperatures are needed to obtain sufficient conversion of carbon dioxide into carbon monoxide to make the process economically feasible.

### SUMMARY

The present invention provides a plant comprising a reverse water gas shift (RWGS) section comprising
   a first feed comprising hydrogen to the RWGS section, and a second feed comprising carbon dioxide to the RWGS section, or a combined feed comprising hydrogen and carbon dioxide to the RWGS section,
   a water removal section downstream the RWGS section,
a compressor downstream the water removal section, and
a cryogenic CO₂ separation section downstream the compressor,
   wherein said RWGS section is arranged to convert said first feed and said second feed—or said combined feed—into a first syngas stream, and feed the first syngas stream to the water removal section,
   wherein said water removal section is arranged to remove water from the first syngas stream to produce a dehydrated syngas stream and a water condensate,
   wherein the dehydrated syngas is compressed in the compressor to form a compressed syngas stream,
   wherein said cryogenic CO2 separation section is arranged to separate the compressed syngas stream into a CO2 depleted syngas stream and a CO2 rich condensate,
   wherein the plant has means for recycling at least a portion of the CO2 rich condensate to the RWGS section or to a feed to the RWGS section, and
   wherein the RWGS section is an electrically heated RWGS (e-RWGS) section.

In a reverse water gas shift (RWGS) process step it is unavoidable that the resulting product syngas contains a certain level of CO2 due to the thermodynamics of the reaction. The content of CO2 in the syngas is undesired, because it acts as an inert reactant in some downstream synthesis processes and hence reduces the overall process economy. The present invention is based on the recognition that a subjection of the syngas from the RWGS step to a cryogenic CO2 separation step involves a number of advantages.

Firstly, a cryogenic CO2 separation unit operates at a high pressure, which may be at the same level as the pressure of the RWGS section or even higher. This means that a cryogenic CO2 separation section provides a possibility of recycling CO2 separated therein to the RWGS section without the need for a compressor, and thereby such recycling of CO2 is made economically profitable.

Secondly, the high pressure of a cryogenic CO2 separation unit has provided a possibility of providing a CO2 depleted syngas at a high pressure for downstream synthesis, e.g. for the Fischer-Tropsch reaction and for direct use of CO, which again eliminates the need for a separate compressor.

Thirdly, the use of a cryogenic CO2 separation unit in combination with a RWGS section makes it possible to allow a slip of CO2 in the RWGS section to a higher level and hence provides a possibility of operating the RWGS section in conditions not selected to minimize the CO2 level of the syngas product.

Furthermore, the use of an electrically heated RWGS (e-RWGS) section in combination with the use of a cryogenic CO2 separation section and the recycling of CO2 from the latter to the former section in the plant of the invention involves the following advantages. Firstly, the plant has provided a possibility of converting a highly increased amount of the CO2, and even all of the CO2, supplied to the plant as feed into CO in the CO2 depleted syngas product stream in the overall plant configuration scheme. Consequently, the invention allows for very high hydrogen and CO2 feed utilisation efficiencies and no CO2 waste product.

Secondly, in a plant comprising a conventional fired RWGS section, the RWGS section is fired with a hydrocarbon fuel, e.g. lighter hydrocarbons recycled from a downstream Fischer-Tropsch unit. The plant of the invention has provided a possibility of avoiding CO2 emissions from the plant by avoiding the need for using a hydrocarbon fuel for firing the RWGS section. In contrast, the eRWGS section of the invention may be operated using sustainable electricity only hence avoiding CO2 emission altogether.

Finally, the present invention provides the possibility of producing a syngas for the downstream synthesis stage with a very low level of CO2.

The plant makes effective use of various streams; in particular CO2. A method for producing a syngas product stream is also provided, which uses the plant set out above.

Thus, the present invention further provides a process comprising the steps of
providing a plant as defined in any of the preceding claims,
supplying the first feed comprising hydrogen to the RWGS section, and supplying the second feed comprising carbon dioxide to the RWGS section, or supplying said combined feed comprising hydrogen and carbon dioxide to the e-RWGS section,
removing water from the first syngas stream in the water removal section to produce a dehydrated syngas stream and a water condensate,
separating the dehydrated syngas stream into a CO2 depleted syngas stream and a CO2 rich condensate in the cryogenic CO2 separation section, and
recycling at least a portion of the CO2 rich condensate to the RWGS section or to a feed to the RWGS section.

Further details of the technology are provided in the enclosed dependent claims, figures and examples.

### LEGENDS TO THE FIGURES

The technology is illustrated by means of the following schematic illustrations, in which:

FIG. 1 shows a first embodiment of the plant of the invention

FIG. 2 shows a second embodiment of the plant of the invention

### DETAILED DISCLOSURE

Unless otherwise specified, any given percentages for gas content are % by volume.

Carbon capture and utilization has gained more attention over the years. The proposed layout provides a solution for CO₂ utilization in presence of H₂ to produce syngas and subsequently, such syngas may be converted to valuable products, such as syngas derived liquid fuel, also known as synfuels. For conversion of CO₂ and H₂ feeds to syngas, primarily electrically heated RWGS (e-RWGS) section is used.

In the present technology, carbon dioxide and hydrogen feeds are primarily processed in an e-RWGS section.

The term “synthesis gas” is meant to denote a gas comprising hydrogen, carbon monoxide and also carbon dioxide and small amounts of other gasses, such as argon, nitrogen, methane, etc.

In one embodiment, the plant comprises:
a first feed comprising hydrogen to the e-RWGS section; and
a second feed comprising carbon dioxide to the e-RWGS section

As an alternative to a separate first feed and a separate second feed, the plant may comprise a combined feed comprising hydrogen and carbon dioxide to the e-RWGS section.

The e-RWGS section is arranged to convert at least a portion of said first feed and at least a portion of said second feed—or at least a portion of said combined feed—into a first syngas stream.

In one aspect, the first feed comprising hydrogen to the e-RWGS section and the second feed comprising carbon dioxide to the e-RWGS section are arranged to be mixed to provide a combined feed which is provided to the e-RWGS section.

The first syngas stream suitably has the following composition (by volume):
40-70% H₂ (dry)
10-40% CO (dry)
2-20% CO₂ (dry)

The first syngas stream may additionally contain other components such as methane, steam, and/or nitrogen.

### First Feed

A first feed comprising hydrogen is provided to the syngas stage (A). Suitably, the first feed consists essentially of hydrogen. The first feed of hydrogen is suitably “hydrogen rich” meaning that the major portion of this feed is hydrogen; i.e. over 75%, such as over 85%, preferably over 90%, more preferably over 95%, even more preferably over 99% of this feed is hydrogen. One source of the first feed of hydrogen can be one or more electrolyser units. In addition to hydrogen the first feed may for example comprise steam, nitrogen, argon, carbon monoxide, carbon dioxide, and/or hydrocarbons. In some cases a minor content of oxygen may be present in this feed, typically less than 100 ppm. The first feed suitably comprises only low amounts of hydrocarbon, such as for example less than 5% hydrocarbons or less than 3% hydrocarbons or less than 1% hydrocarbons.

In an embodiment, the first feed at least partly is provided from an electrolysis unit, such as alkaline electrolysis, proton exchange membrane and/or solid oxide cell electrolysis.

### Second Feed

A second feed comprising carbon dioxide is provided to the syngas stage (A). Suitably, the second feed consists essentially of CO₂. The second feed of CO₂ is suitably “CO₂ rich” meaning that the major portion of this feed is CO₂; i.e. over 75%, such as over 85%, preferably over 90%, more preferably over 95%, even more preferably over 99% of this feed is CO₂. One source of the second feed of carbon dioxide can be one or more exhaust stream(s) from one or more chemical plant(s). One source of the second feed of carbon dioxide can also be carbon dioxide captured from one or more process stream(s) or atmospheric air. Another source of the second feed could be CO₂ captured or recovered from the flue gas for example from fired heaters, steam reformers, and/or power plants. The second feed may in addition to CO₂ comprise for example steam, oxygen, nitrogen, oxygenates, amines, ammonia, carbon monoxide, and/or hydrocarbons. The second feed suitably comprises only low amounts of hydrocarbon, such as for example less than 5% hydrocarbons or less than 3% hydrocarbons or less than 1% hydrocarbons.

The second feed comprising carbon dioxide may—alternatively or additionally—be a stream comprising CO and CO₂, which is output from an electrolysis section arranged to convert a feed of CO₂ into a stream comprising CO and CO₂.

In a particular aspect, a portion of a CO₂ stream is fed directly to the RWGS section as said second feed comprising carbon dioxide, while another portion of this CO₂ stream is fed to an electrolysis section, where it is converted to a stream comprising CO and CO₂. The stream comprising CO and CO₂ may then be fed to the RWGS section.

### Combined Feed

As an alternative to separate first feed and second feed, the plant may comprise a combined feed comprising hydrogen and carbon dioxide to the e-RWGS section. Typically, the hydrogen content of this combined feed is between 40 and 80%, preferably between 50 and 70%.

Typically, the carbon dioxide content of this combined feed is between 15 and 50% %, preferably between 20 and 40%. Typically, the carbon monoxide content of this combined feed is between 0 and 10%. Typically, the ratio of hydrogen to carbon dioxide in this combined feed is between 1 and 5, preferably between 2 and 4.

In addition to hydrogen and carbon dioxide, the combined feed may for example comprise steam, nitrogen, argon, carbon monoxide, and/or hydrocarbons. The combined feed suitably comprises only low amounts of hydrocarbon, such as for example less than 5% hydrocarbons or less than 3% hydrocarbons or less than 1% hydrocarbons.

Part of the combined feed may be produced by co-electrolysis of a water/steam feed and a CO₂ feed.

### Third Feed

A third feed comprising hydrocarbons, external to the plant may be provided to the RWGS section and/or a reforming section. The third feed may additionally comprise other components such as CO₂ and/or CO and/or H₂ and/or steam and/or other components such as nitrogen and/or argon. Suitably, the third feed consists essentially of hydrocarbons or a mixture of hydrocarbons and steam. The third feed of hydrocarbons is suitably “hydrocarbon rich” meaning that the major portion of this feed is hydrocarbons; i.e. over 25%, e.g. over 50%, e.g. over 75%, such as over 85%, preferably over 90%, more preferably over 95%, even more preferably over 99% of this feed is hydrocarbons. The concentration of hydrocarbons in this third feed is determined prior to steam addition (i.e. determined as “dry concentration”).

An example of such third feed can also be a natural gas stream external to the plant. In one aspect, said third feed comprises one or more hydrocarbons selected from methane, ethane, propane or butanes.

The source of the third stream comprising hydrocarbons is external to the plant. The significance of a stream “external to the plant” is that the origin of the stream is not a recycle stream (or a recycle stream further processed or converted) from any synthesis stage in the plant. Possible sources of a third feed comprising hydrocarbons external to the plant include natural gas, LPG, refinery off-gas, naphtha, and renewables, but other options are also conceivable.

### RWGS Reaction

Undesired by-product formation of, for example methane, take place according to one or both of the methanation reactions:

CO(g)+3H₂(g)↔CH₄(g)+H₂O(g) (2)

CO₂(g)+4H₂(g)↔CH₄(g)+2H₂O(g) (3)

In the following the wording “selective RWGS” shall mean that only the reverse water gas shift reaction takes place either on a catalyst or in a reactor while “non-selective RWGS” shall mean that other reactions such as one or more of the methanation reactions (including also reverse methanation) takes place in addition to reverse water gas shift.

In one embodiment, the catalytically active material catalyzes selective RWGS. In an alternative embodiment, the catalytically active material catalyzes non-selective RWGS.

e-RWGS Section

In the plant of the invention, the RWGS section is an electrically heated reverse water gas shift (e-RWGS) section. Electrically-heated reverse water gas shift (e-RWGS) uses an electric resistance-heated reactor to perform a more efficient reverse water gas shift process and substantially reduces or preferably avoids the use of fossil fuels as a heat source.

An e-RWGS section is used in the present invention for carrying out the reverse water-gas shift reaction between CO₂ and H₂. In a first embodiment the e-RWGS section suitably comprises:
a structured catalyst comprising a macroscopic structure of electrically conductive material capable of catalysing both reverse water gas shift reaction and methanation reaction, said structured catalyst comprising a macroscopic structure of electrically conductive material, said macroscopic structure supporting a ceramic coating, wherein said ceramic coating supports a catalytically active material (for selective e-RGWS);
a pressure shell housing said structured catalyst; said pressure shell comprising an inlet for letting in said feed and outlet for letting syngas product; wherein said inlet is positioned so that said feed enters said structured catalyst in a first end of said structured catalyst and said syngas product exits said structured catalyst from a second end of said structured catalyst;
a heat insulation layer between said structured catalyst and said pressure shell; and
at least two conductors electrically connected to said structured catalyst and to an electrical power supply placed outside said pressure shell, wherein said electrical power supply is dimensioned to heat at least part of said structured catalyst to a temperature of at least 500° C. by passing an electrical current through said macroscopic structure of electrically conductive material; wherein said at least two conductors are connected to the structured catalyst at a position on the structured catalyst closer to said first end of said structured catalyst than to said second end of said structured catalyst, and wherein the structured catalyst is constructed to direct an electrical current to run from one conductor substantially to the second end of the structured catalyst and return to a second of said at least two conductors, and wherein the structured catalyst has electrically insulating parts arranged to direct the current from one conductor, which is closer to the first end of the structured catalyst than to the second end, towards the second end of the structured catalyst and back to a second conductor closer to the first end of the structured catalyst than to the second end.

In a second embodiment, the e-RWGS section suitably comprises:
a structured catalyst comprising a macroscopic structure of electrically conductive material capable of catalysing both reverse water gas shift reaction and methanation reaction, said structured catalyst comprising a macroscopic structure of electrically conductive material, said macroscopic structure supporting a ceramic coating, wherein said ceramic coating supports a catalytically active material (for non-selective e-RWGS);
optionally a top layer arranged on top of the structured catalyst, comprising pellet catalyst, capable of catalysing both the methanation reaction and the reverse water gas shift reaction (for non-selective e-RWGS);
optionally a bottom layer arranged below the structured catalyst, comprising pellet catalyst, capable of catalysing both the methanation reaction and the reverse water gas shift reaction (for non-selective e-RWGS);
a pressure shell housing said structured catalyst; said pressure shell comprising an inlet for letting in said feed and outlet for letting syngas product; wherein said inlet is positioned so that said feed enters said structured catalyst in a first end of said structured catalyst and said syngas product exits said structured catalyst from a second end of said structured catalyst;
a heat insulation layer between said structured catalyst and said pressure shell; and
at least two conductors electrically connected to said structured catalyst and to an electrical power supply placed outside said pressure shell, wherein said electrical power supply is dimensioned to heat at least part of said structured catalyst to a temperature of at least 500° C. by passing an electrical current through said macroscopic structure of electrically conductive material; wherein said at least two conductors are connected to the structured catalyst at a position on the structured catalyst closer to said first end of said structured catalyst than to said second end of said structured catalyst, and wherein the structured catalyst is constructed to direct an electrical current to run from one conductor substantially to the second end of the structured catalyst and return to a second of said at least two conductors, and wherein the structured catalyst has electrically insulating parts arranged to direct the current from one conductor, which is closer to the first end of the structured catalyst than to the second end, towards the second end of the structured catalyst and back to a second conductor closer to the first end of the structured catalyst than to the second end.

The pressure shell suitably has a design pressure of between 2 and 30 bar. The pressure shell may also have a design pressure of between 30 and 200 bar. The at least two conductors are typically led through the pressure shell in a fitting so that the at least two conductors are electrically insulated from the pressure shell. The pressure shell further comprises one or more inlets close to or in combination with at least one fitting in order to allow a cooling gas to flow over, around, close to, or inside at least one conductor within said pressure shell. The exit temperature of the e-RWGS section (I) is suitably 900° C. or more, preferably 1000° C. or more, even more preferably 1100° C. or more.

In an embodiment of the plant of the invention, said e-RWGS section comprises a structured catalyst comprising a macroscopic structure of electrically conductive material capable of catalysing both a reverse water gas shift reaction and a methanation reaction.

In case of non-selective e-RWGS, methanation according to reactions (2) and/or (3) takes place in addition to the RWGS reaction. This has the advantage that the concentration of carbon monoxide internally in the reactor is lower than if only reverse water gas shift takes place. This is especially important in the low to moderate temperature range up to ca. 600-800° C. In this temperature range a potential for carbon formation or metal dusting exists or is significantly larger with a selective RWGS catalyst than with a non-selective catalyst.

In one embodiment, the methanation reaction(s) also occur at and near the inlet of the reactor. However, at a given temperature (depends on the feed gas composition, pressure, catalyst activity, extent of heat supply and other factors) the reverse of the methanation reaction will be thermodynamically favoured. In other words, in the first part of the RWGS reactor methane will be formed and in the second part downstream of the first part methane will be consumed according to the reverse of reactions (2) and/or (3).

In one embodiment of the eRWGS reactor of the invention, the eRWGS reactor comprises a structured catalyst. The said structured catalyst has a first reaction zone disposed closest to the first end of said structured catalyst, wherein the first reaction zone has an overall exothermic reaction, and a second reaction zone disposed closest to the second end of said structured catalyst, wherein the second reaction zone has an overall endothermic reaction. Preferably, said first reaction zone has an extension of between the first 5% to between the first 60% of the length of the total reaction zone in the reactor, wherein reaction zone is understood as the volume of the reactor system catalyzing the methanation and reverse water gas shift reactions as evaluated along the flow path through the catalytic zone.

The combined activity for both reverse water gas shift and methanation in an eRWGS reactor of the invention entails that the reaction scheme inside the reactor will start out as exothermic in the first part of the reactor system but end as endothermic towards the exit of the reactor system. This relates to the heat of reaction (Qᵣ) added or removed during the reaction, according to the general heat balance of the plug flow reactor system:

$$F \cdot {C}_{p m} \cdot dT / dV = {Q}_{a d d} + {Q}_{r} = {Q}_{a d d} + \sum \{ - {Δ}_{r} {H}_{i} ) \cdot ( - {r}_{i} )$$

where F is the flow rate of process gas, Cₚₘ is the heat capacity, V the volume of the reaction zone, T the temperature, Q_{add} the energy supply/removal from the surrounding, and Qᵣ the energy supply/removal associated with chemical reactions which are given as the sum of all chemical reactions facilitated within the volume and calculated as the product between the reaction enthalpy and the rate of reaction of a given reaction.

In one embodiment when using a non-selective RWGS reactor the methane concentration by volume in the gas leaving the e-RWGS reactor is lower than 6% such as lower than 4% or preferably less than 3%. High product gas temperature ensures that the final syngas product has low methane concentration, despite the methane concentration has a peak somewhere along the reaction zone. Therefore, this reactor configuration can be operated with none, or little, methane in the feed and only little methane in the product gas, but with a peak in methane concentration inside the reaction zone higher than in the feed and/or product gas. It is advantageous in most cases that the concentration of methane in the synthesis gas is as low as possible as methane does not act as a reactant in downstream synthesis such as methanol or Fischer-Tropsch.

In one embodiment the methane concentration in the e-RWGS section is higher than both the concentration of the inlet gas to the e-RWGS section and the concentration of the exit gas from the e-RWGS section.

The e-RWGS section comprises one or more e-RWGS reactors, and in one embodiment, consists of a single e-RWGS reactor. In this embodiment the methane concentration at (at least) one point inside the reactor may be higher than both the methane concentration of the reactor feed gas and the reactor exit gas.

A low concentration of methane can be achieved by a high temperature out of the e-RWGS reactor. A high temperature has the further advantage that a higher conversion of CO₂ into CO. In an embodiment the exit temperature of the gas from the e-RWGS reactor is higher 900° C., such than higher than 1000° C. or even higher than 1050° C. It is an advantage of the proposed reactor that a higher temperature can be achieved than what is typically possible with an externally fired reactor.

Another means to have a low concentration at the exit of the e-RWGS reactor is to have a low to moderate pressure, such as between 5 and 20 bars or between 8 and 12 bars. In this embodiment the gas leaving the e-RWGS section will typically be cooled and water will be (partially) removed by condensation followed by compression to the desired pressure for downstream applications.

In one embodiment, a reactor may be present upstream the e-RWGS section. This reactor may be adiabatic or cooled and the catalyst will typically be pellet based. Part or all of the first feed and part or all of the second feed are directed to this reactor. In the reactor the RWGS and methanation reactions (1-3) take place. The exit temperature from this reactor is typically in the range between 400-700° C. The effluent from this reactor is fed to the e-RWGS section optionally after cooling and condensation of part of the formed H₂O. This has the advantage that the amount of CO₂ in the effluent from the e-RWGS section will be lower.

In a specific embodiment a gas comprising carbon monoxide, carbon dioxide, hydrogen, and methane is combined with the 3^{rd} feed comprising hydrocarbons (e.g. tail gas or light end hydrocarbons) to the e-RWGS section. Alternatively, the third feed is composed solely of said gas comprising carbon monoxide, carbon dioxide, hydrogen, and methane One example could be a tail gas from a Fischer-Tropsch synthesis section. Such a gas could for example contain:

| | |
|---|---|
| 10-30% | CO |
| 20-70% | CO₂ |
| 10-30% | H₂ |
| 5-25% | CH₄ |
| 0.2-10% | other hydrocarbons |

Such a stream could be added directly to the e-RWGS section. Alternatively, this stream is initially passed through a water gas shift reactor together with steam (reverse of reaction 1 above):

CO+H₂O↔H₂+CO₂ (6)

This reduces the CO-concentration at the inlet to the e-RWGS section reducing the potential for carbon formation.

The effluent from the water gas shift reactor may also be directed to another reactor (higher hydrocarbon removal reactor). This higher hydrocarbon removal reactor may be adiabatic or cooled and the catalyst will typically be pellet based. In this higher hydrocarbon removal reactor, the RWGS reaction (1) (or the shift reaction (6)) and methanation reactions (2-3) or the reverse methanation reactions (depending upon the gas composition, temperature, and pressure) take place. Furthermore, steam reforming of higher hydrocarbons may take place in this reactor:

CₙHₘ+nH₂O→nCO+(m/2+n)H₂ (7)

The conditions of the reactor are preferably adjusted to convert more than 90%, such as more than 95% of the non-methane hydrocarbons present in the feed mixture. Removal or substantial reduction of non-methane hydrocarbons has the advantage that the risk of carbon formation in the e-RWGS reactor(s) in the e-RWGS section is reduced considerably.

The exit temperature from this higher hydrocarbon removal reactor is typically in the range between 400-700° C. The effluent from this reactor is fed to the e-RWGS section optionally after cooling and condensation of part of the formed H₂O. This has the advantage that the amount of CO₂ in the effluent from the e-RWGS section will be lower. The effluent may be mixed with the first feed and the second feed before being fed to the e-RWGS section.

The e-RWGS reactor may further comprise an inner tube in heat exchange relationship with but electrically insulated from the structured catalyst, said inner tube being adapted to withdraw a product gas from the structured catalyst so that the gas flowing through the inner tube is in heat exchange relationship with gas flowing over the structured catalyst. The connection between the structured catalyst and said at least two conductors may be a mechanical connection, a welded connection, a brazed connection or a combination thereof.

The electrically conductive material suitably comprises an 3D printed or extruded and sintered macroscopic structure, said macroscopic structure supporting a ceramic coating, wherein said ceramic coating supports a catalytically active material. The structured catalyst may comprise an array of macroscopic structures electrically connected to each other. The macroscopic structure may have a plurality of parallel channels, a plurality of non-parallel channels and/or a plurality of labyrinthic channels. The reactor typically further comprises a bed of a second catalyst material upstream said structured catalyst within said pressure shell.

In one aspect, the e-RWGS reactor further comprises a catalyst material in the form of catalyst pellets, extrudates or granulates loaded into the channels of said macroscopic structure. The e-RWGS reactor may further comprise a control system arranged to control the electrical power supply to ensure that the temperature of the gas exiting the pressure shell lies in a predetermined range and/or to ensure that the conversion of the feed gas lies in a predetermined range.

As used herein, the term “macroscopic structure” is meant to denote a structure which is large enough to be visible with the naked eye, without magnifying devices. The dimensions of the macroscopic structure are typically in the range of centimeters or even meters. Dimensions of the macroscopic structure are advantageously made to correspond at least partly to the inner dimensions of the pressure shell, saving room for the heat insulation layer and conductors.

A ceramic coating, with or without catalytically active material, may be added directly to a metal surface by wash coating. The wash coating of a metal surface is a well-known process; a description is given in e.g. Cybulski, A., and Moulijn, J. A., Structured catalysts and reactors, Marcel Dekker, Inc, New York, 1998, Chapter 3, and references herein. The ceramic coating may be added to the surface of the macroscopic structure and subsequently the catalytically active material may be added; alternatively, the ceramic coat comprising the catalytically active material is added to the macroscopic structure.

Preferably, the macroscopic structure has been manufactured by extrusion of a mixture of powdered metallic particles and a binder to an extruded structure and subsequent sintering of the extruded structure, thereby providing a material with a high geometric surface area per volume. A ceramic coating, which may contain the catalytically active material, is provided onto the macroscopic structure before a second sintering in an oxidizing atmosphere, in order to form chemical bonds between the ceramic coating and the macroscopic structure. Alternatively, the catalytically active material may be impregnated onto the ceramic coating after the second sintering. When chemical bonds are formed between the ceramic coating and the macroscopic structure, an especially high heat conductivity between the electrically heated macroscopic structure and the catalytically active material supported by the ceramic coating is possible, offering close and nearly direct contact between the heat source and the catalytically active material of the macroscopic structure. Due to close proximity between the heat source and the catalytically active material, the heat transfer is effective, so that the macroscopic structure can be very efficiently heated. A compact reforming reactor in terms of gas processing per reforming reactor volume is thus possible, and therefore the reforming reactor housing the macroscopic structure may be compact. The reforming reactor of the invention does not need a furnace, and this reduces the size of the electrically heated reforming reactor considerably.

Preferably, the conductors are made of different materials than the macroscopic structure. The conductors may for example be of iron, nickel, aluminum, copper, silver, or an alloy thereof. The ceramic coating is an electrically insulating material and will typically have a thickness in the range of around 100 μm, say 10-500 μm. In addition, a catalyst may be placed within the pressure shell and in channels within the macroscopic structure, around the macroscopic structure or upstream and/or downstream the macroscopic structure to support the catalytic function of the macroscopic structure.

In an e-RWGS reactor, the structured catalyst within said reactor system may have a ratio between the area equivalent diameter of a horizontal cross section through the structured catalyst and the height of the structured catalyst in the range from 0.1 to 2.0.

Preferably, the macroscopic structure comprises Fe, Ni, Cu, Co, Cr, Al, Si or an alloy thereof. Such an alloy may comprise further elements, such as Mn, Y, Zr, C, Co, Mo or combinations thereof. Preferably, the catalytically active material is particles having a size from 5 nm to 250 nm. The catalytically active material may e.g. comprise copper, nickel, ruthenium, rhodium, iridium, platinum, cobalt, or a combination thereof. Thus, one possible catalytically active material is a combination of nickel and rhodium and another combination of nickel and iridium. The ceramic coating may for example be an oxide comprising Al, Zr, Mg, Ce and/or Ca. Exemplary coatings are calcium aluminate or a magnesium aluminum spinel. Such a ceramic coating may comprise further elements, such as La, Y, Ti, K, or combinations thereof.

In one aspect of the plant, the ratio of moles of carbon in the third feed comprising hydrocarbons, preferably in the case when the third feed is external to the plant, to the moles of carbon in CO₂ in the second feed is less than 0.3, preferably less than 0.25 and more preferably less than 0.20 or even lower than 0.10.

By use of an e-RWGS section (as compared to a regular, fired RWGS section), it is possible to produce a product gas with low content of CO₂, which is desired for some applications, e.g. F-T synthesis or methanol synthesis, since the high temperature of e-RWGS operation ensures a high conversion of CO₂ to CO.

### Water Separation Section

In an embodiment, the water removal section is selected from the group consisting of a flash separation unit, a pressure swing adsorption (PSA) unit, a temperature swing adsorption (TSA) unit, or a combination thereof.

In an embodiment, the water separation section of the plant is a flash separation unit. The flash separation unit is often preceded by suitable temperature reduction equipment. By flash separation is meant a phase separation unit, where a stream is divided into a liquid and gas phase close to or at the thermodynamic phase equilibrium at a given temperature.

In an embodiment, the water separation section of the plant is a pressure swing adsorption unit (PSA unit) or a temperature swing adsorption unit (TSA unit). By swing adsorption, a unit for adsorbing selected compounds is meant. In this type of equipment, a dynamic equilibrium between adsorption and desorption of gas molecules over an adsorption material is established. The adsorption of the gas molecules can be caused by steric, kinetic, or equilibrium effects. The exact mechanism will be determined by the used adsorbent and the equilibrium saturation will be dependent on temperature and pressure. Typically, the adsorbent material is treated in the mixed gas until near saturation of the heaviest compounds and will subsequently need regeneration. The regeneration can be done by changing pressure or temperature. In practice, this means that a process with at least two units is used, saturating the adsorbent at high pressure or low temperature initially in one unit, and then switching unit, now desorbing the adsorbed molecules from the same unit by decreasing the pressure or increasing the temperature. When the unit operates with changing pressures, it is called a pressure swing adsorption unit, and when the unit operates with changing temperature, it is called a temperature swing adsorption unit.

### Cryogenic CO2 Separation Section

Cryogenic separation typically utilizes the phase change of different species in the gas to separate individual components (i.e. CO2) from a gas mixture by controlling the temperature, typically taking place below −50° C. Such a cryogenic separation unit typically comprises a first cooling stage of the synthesis gas, followed by cryogenic flash separation unit to separate the liquid condensate from the gas phase. Cooling for the first cooling stage may be provided by the resulting product from the cryogenic flash separation unit, potentially in the combination with other coolants. Optionally, one or more of the products from the CO2 removal unit may be expanded to some extent to make a colder process gas for this cooling stage. Cryogenic separation of CO2 must be facilitated at elevated pressure, at least above the triple point of CO2 to allows condensation of CO2. A suitable pressure regime is therefore at least above the triple point of 5 bar, where increased pressure gives increased liquid yields.

In an embodiment of the invention, the cryogenic CO2 separation section is operated at a temperature of from ca. −30° C. to −80° C. In an embodiment of the invention, the amount of CO2 condensed in the cryogenic separation is increased by reducing the operation temperature.

In an embodiment, the cryogenic CO2 separation section comprises a cooling unit, followed by a flash separation unit, followed by a heating unit. In an embodiment, the cryogenic CO2 separation section comprises a gas dryer unit. Preferably, the gas dryer unit is the first unit of the cryogenic CO2 separation section.

### Compressors

In an embodiment of the plant of the inventions, the means for recycling at least a portion of the CO2 rich condensate does not comprise a compressor for compressing the CO2 rich condensate.

In an embodiment of the invention, the plant does not comprise any compressor downstream the cryogenic CO2 separation section.

### Synthesis Stage

In an embodiment of the invention, the plant comprises a synthesis stage downstream the cryogenic CO2 separation section, and wherein the cryogenic CO2 separation section is arranged to feed the CO2 depleted syngas to the synthesis stage. Suitably, the synthesis stage is arranged to convert said CO2 depleted syngas stream into at least a hydrocarbon product stream and, optionally, a hydrocarbon-containing off-gas stream.

In an embodiment of the invention, said synthesis stage comprises a synfuel synthesis section, an alcohol synthesis section or an olefin synthesis section.

Examples of synfuels end products are Diesel Fuel, Jet Fuel and Gasoline.

In an embodiment of the invention, wherein said synthesis stage comprises a synfuel synthesis section, said synthesis stage further comprises a Fischer-Tropsch (FT) section upstream the synfuel synthesis section.

The synthesis section may comprise other process units, such as—compressor, heat exchanger, separator etc.

Suitably, the syngas stream at the inlet of said synthesis stage has a hydrogen/carbon monoxide ratio in the range 1.00-4.00; preferably 1.50-3.00, more preferably 1.50-2.10.

In one embodiment, the H2/CO ratio in said CO2 depleted syngas stream is between approximately 0.5 and 4.5.

In particular, the synthesis stage may comprise a Fischer-Tropsch (F-T) stage arranged to convert said syngas stream into at least a hydrocarbon product stream and a hydrocarbon-containing off-gas stream in the form of an F-T off-gas stream. In this aspect, at least a portion of said hydrocarbon-containing off-gas stream may be recycled to the RWGS section as said third feed comprising hydrocarbons or in addition to said third feed comprising hydrocarbons. This increases the overall carbon efficiency. In an embodiment, the plant comprises a compressor for compressing the F-T off-gas to be recycled to the RWGS section.

In another aspect, the synthesis stage comprises a methanol synthesis stage arranged to provide at least a methanol product stream.

Additionally, the ratio of H₂:CO₂ provided at the plant inlet may be between 1.0-9.0, preferably 2.5-8.0, more preferably 3.0-7.0.

A feed of hydrogen may be arranged to be combined with the CO₂ depleted syngas stream, upstream the synthesis stage. This allows the required ratio of H₂:CO₂ to be adjusted as required.

### Reforming Section

The syngas stage of the present invention may advantageously comprise one or more additional sections, other than the e-RWGS section described above.

In one aspect, the plant may comprise a reforming section arranged in parallel to said e-RWGS section; wherein said plant comprises a third feed comprising hydrocarbons to said reforming section, and wherein said reforming section is arranged to convert at least a portion of said third feed into a second syngas stream.

The second syngas stream may have the following composition (by volume):
40-70% H₂ (dry)
10-30% CO (dry)
2-20% CO₂ (dry)
0.5-5% CH₄

In this aspect, the first syngas stream from the e-RWGS section is arranged to be combined with the second syngas stream from the reforming section to provide a combined syngas stream. This combined syngas stream is arranged to be fed to the synthesis stage.

According to this aspect, the reforming section may be selected from the group consisting of an autothermal reforming (ATR) section, a steam methane reforming (SMR) section and an electrically heated steam methane reforming (e-SMR) section.

In one aspect, the reforming section is an autothermal reforming (ATR) section. In this aspect, the plant further comprises a fourth feed comprising steam and—optionally—a fifth feed comprising oxygen to the autothermal reforming (ATR) section (IIa). A fourth feed comprising steam will also be required if the reforming section is an SMR or an e-SMR

In another aspect, the reforming section is an electrically heated steam methane reforming (e-SMR) section. In this aspect, the plant does not comprise a feed comprising oxygen to the electrically heated steam methane reforming (e-SMR) section. With this aspect, overall CO₂ output from the plant can be reduced.

In one aspect, at least a portion of the second feed comprising carbon dioxide is fed to the reforming section.

The third feed comprising hydrocarbons may be a natural gas feed.

In one aspect, the plant may comprise an autothermal reforming (ATR) section, comprising one or more autothermal reactors (ATR), and wherein first, second, third, and fourth feeds are fed to said ATR section. As an alternative, at least a portion of the combined feed may be fed to the ATR section. Part or all of the third feed may be desulfurized and pre-reformed. All feeds are preheated as required. The key part of the ATR section is the ATR reactor. The ATR reactor typically comprises a burner, a combustion chamber, and a catalyst bed contained within a refractory lined pressure shell. In an ATR reactor, partial combustion of the hydrocarbon containing feed by sub-stoichiometric amounts of oxygen is followed by steam reforming of the partially combusted hydrocarbon feed stream in a fixed bed of steam reforming catalyst. Steam reforming also takes place to some extent in the combustion chamber due to the high temperature. The steam reforming reaction is accompanied by the water gas shift reaction. Typically, the gas is at or close to equilibrium at the outlet of the reactor with respect to steam reforming and water gas shift reactions.

Typically, the effluent gas from the ATR reactor has a temperature of 900-1100° C. The effluent gas normally comprises H₂, CO, CO₂, and steam. Other components such as methane, nitrogen, and argon may also be present often in minor amounts. The operating pressure of the ATR reactor will be between 5 and 100 bars or more preferably between 15 and 60 bars.

The syngas stream from the ATR is cooled in a cooling train normally comprising a waste heat boiler(s) (WHB) and one or more additional heat exchangers. The cooling medium in the WHB is (boiler feed) water which is evaporated to steam. The syngas stream is further cooled to below the dew point for example by preheating the utilities and/or partial preheating of one or more feed streams and cooling in air cooler and/or water cooler.

Condensed H₂O is taken out as process condensate in a separator to provide a syngas stream with low H₂O content, which is sent to the synthesis stage.

The “ATR section” may be a partial oxidation “POX” section. A POX section is similar to an ATR section except for the fact that the ATR reactor is replaced by a POX reactor. The POX rector generally comprises a burner and a combustion chamber contained in a refractory lined pressure shell.

The ATR section could also be a catalytic partial oxidation (cPOX) section.

In one embodiment the e-RWGS section is followed by a reforming section, which suitably includes an autothermal reformer (ATR). The ATR reactor typically comprises a burner, a combustion chamber, and a catalyst bed contained within a refractory lined pressure shell. In an ATR reactor, partial combustion of the hydrocarbon containing feed by sub-stoichiometric amounts of oxygen is followed by steam reforming of the partially combusted hydrocarbon feed stream in a fixed bed of steam reforming catalyst. Steam reforming also takes place to some extent in the combustion chamber due to the high temperature. The steam reforming reaction is accompanied by the water gas shift reaction. Typically, the gas is at or close to equilibrium at the outlet of the reactor with respect to steam reforming and water gas shift reactions. More details of ATR and a full description can be found in the art such as “Studies in Surface Science and Catalysis, Vol. 152,” Synthesis gas production for FT synthesis “; Chapter 4, p. 258-352, 2004”.”.

In this case, the exit gas from the e-RWGS reactor is directed to an autothermal reformer. In this embodiment the exit gas from the e-RWGS reactor reacts with an oxidant to produce the final synthesis gas. The final synthesis gas in this embodiment typically has a temperature above 950° C., such as above 1020° C., or 1050° C. or above. In this particular embodiment the exit temperature from the e-RWGS reactor will typically be between 600-900° C. such as between 700-850° C. The e-RWGS reactor may in this embodiment either be selective or preferably be non-selective. In one embodiment a feed gas comprising hydrocarbons is added to the exit gas from the e-RWGS reactor upstream of the autothermal reformer. This could for example be tail gas from a downstream Fischer-Tropsch synthesis unit.

In embodiments with an ATR after a non-selective RWGS reactor, the methane concentration leaving the RWGS reactor will preferably be lean, such as less than 20% or preferably less than 12%. A relatively low concentration has the advantage that less oxidant is needed in the autothermal reformer.

In embodiments with an ATR after an RWGS reactor, the gas leaving the RWGS reactor is preferably not cooled (except for heat loss and by mixing with other streams). Cooling of the gas increases the oxygen consumption in the ATR.

The advantage of the embodiment with the ATR is that the power needed for the e-RWGS reactor is reduced due to the lower exit temperature. In one embodiment part or all of the oxygen generated by electrolysis of steam to produce hydrogen for the e-RWGS reactor is used in the autothermal reformer.

The oxidant for the autothermal reformer may either be oxygen, air, a mixture of air and oxygen, or be an oxidant comprising more than 80% oxygen such as more than 90% oxygen. The oxidant may also comprise other components such as steam, nitrogen, and/or Argon. Typically the oxidant in this case will comprise 5-20% steam.

### Electrolysis Section

A sixth feed of hydrogen may be arranged to be combined with the first syngas stream, upstream the synthesis stage. This allows the required ratio of H₂:CO₂ to be adjusted as required.

In one embodiment, the plant further comprises an electrolysis section arranged to convert water or steam into at least a hydrogen stream and an oxygen stream, and at least a part of said hydrogen stream from the electrolysis section is arranged to be fed to the RWGS section as said first feed. Additionally, at least a part of the hydrogen stream from the electrolysis section can be comprised as the sixth feed of hydrogen. A part or all of the water or steam, fed to electrolysis section, may come from RWGS section or synthesis stage.

In the instance where the plant comprises a reforming section being an autothermal reforming (ATR) section, at least a part of the oxygen stream from the electrolysis section is suitably arranged to be fed to the RWGS section as said fifth feed comprising oxygen.

The electrolysis section may also be arranged to convert a feed of CO₂ into a stream comprising CO and CO₂, wherein at least a part of said stream comprising CO and CO₂ from the electrolysis section is arranged to be fed to the RWGS section as at least a portion of said second feed comprising carbon dioxide.

An electrolysis section may also be arranged upstream the eRWGS to convert a feed of CO₂ and a feed of water or steam into part or all of said combined feed comprising hydrogen and carbon dioxide. In other words, a single electrolysis section converts both a feed of CO₂ and a feed of water/steam into the combined feed.

In an embodiment, the electrolysis section is selected from the group consisting of an alkaline electrolysis unit, a proton exchange membrane unit and/or a solid oxide cell electrolysis unit.

### Pre-Treatment of Feeds

In an embodiment, the plant further comprises a gas purification unit and/or a prereforming unit upstream the RWGS section. The gas purification unit is e.g. a desulfurization unit, such as a hydrodesulfurization unit.

In an embodiment, the plant comprises a pre-treatment section, wherein the second feed is pre-treated to remove undesired components. Such undesired components may e.g. be sulphur compounds, higher hydrocarbons, and inorganic species such as alkaline metals.

In the prereformer, the hydrocarbon gas will, together with steam, and potentially also hydrogen and/or other components such as carbon dioxide, undergo prereforming in a temperature range of ca. 350-550° C. to convert higher hydrocarbons as an initial step in the process, normally taking place downstream the desulfurization step. This removes the risk of carbon formation from higher hydrocarbons on catalyst in the subsequent process steps. Optionally, carbon dioxide or other components may also be mixed with the gas leaving the prereforming step to form the feed gas.

### Process of the Invention

The present invention further relates to a process comprising the steps of
providing a plant as defined in any of the preceding claims,
supplying the first feed comprising hydrogen to the RWGS section, and supplying the second feed comprising carbon dioxide to the RWGS section, or supplying said combined feed comprising hydrogen and carbon dioxide to the RWGS section,
removing water from the first syngas stream in the water removal section to produce a dehydrated syngas stream and a water condensate,
compressing the dehydrated syngas stream to form a compressed syngas stream,
separating the compressed syngas stream into a CO2 depleted syngas stream and a CO2 rich condensate in the cryogenic CO2 separation section, and
recycling at least a portion of the CO2 rich condensate to the RWGS section or to a feed to the RWGS section.

In an embodiment of the process of the invention, the CO2 rich condensate is recycled to the RWGS section without being subjected to compression.

In an embodiment of the process of the invention, the CO2 depleted syngas stream is subjected to treatment in a synthesis stage downstream the cryogenic CO2 separation section.

In an embodiment of the process of the invention, the synthesis stage comprises a synfuel synthesis section, an alcohol synthesis section or an olefin synthesis section.

In an embodiment of the process of the invention, said synthesis stage comprises a synfuel synthesis section, and wherein the said synthesis stage further comprises a Fischer-Tropsch (FT) section upstream the synfuel synthesis section.

In an embodiment of the process of the invention, the CO2 depleted syngas stream is not subjected to compression.

In an embodiment of the process of the invention, the cryogenic CO2 separation section is operated at a temperature of from ca. −30° C. to −80° C. In an embodiment of the process of the invention, the amount of CO2 condensed in the cryogenic separation is increased by reducing the operation temperature.

In an embodiment of the process of the invention, said CO2 depleted syngas stream has a module of (H₂−CO₂)/(CO+CO₂) in the range from 1.8 to 2.2, and wherein the synthesis stage comprises a methanol synthesis section.

In an embodiment of the process of the invention, said synthesis stage comprises Fischer-Tropsch synthesis reactor system for crude oil and/or wax production.

In an embodiment of the process of the invention, said CO₂ depleted syngas stream has a module of (CO+H₂)/(CO₂+H₂O)>7.5.

In an embodiment of the process of the invention, said CO₂ depleted syngas stream has a ratio of H₂/CO<1.5.

In an embodiment of the process of the invention, both a reverse water gas shift reaction and a methanation reaction take place in the RWGS section.

### SPECIFIC EMBODIMENTS

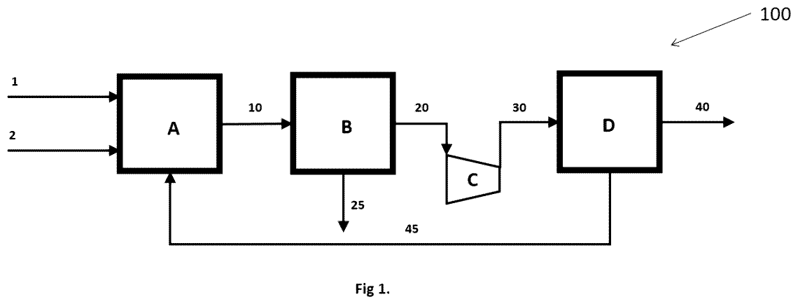

FIG. 1 shows an embodiment of the plant 100 of the invention comprising a RWGS section A, a water removal section B, a compressor C and a cryogenic CO2 separation section D. A H2 feed 1 and a CO2 feed 2 is fed to the RWGS section A, wherein said feeds are converted to a first syngas stream 10. The first syngas stream 10 is supplied to the water removal section B, wherein a water condensate 25 is removed, and from which a dehydrated syngas stream 20 is supplied to the compressor C. A dehydrated, compressed syngas stream 30 is discharged from the compressor C and fed to the cryogenic CO2 separation section D, wherein the dehydrated, compressed syngas stream 30 is separated into a CO2-depleted syngas 40 and a CO2 rich condensate 45, which is recycled to the RWGS section A.

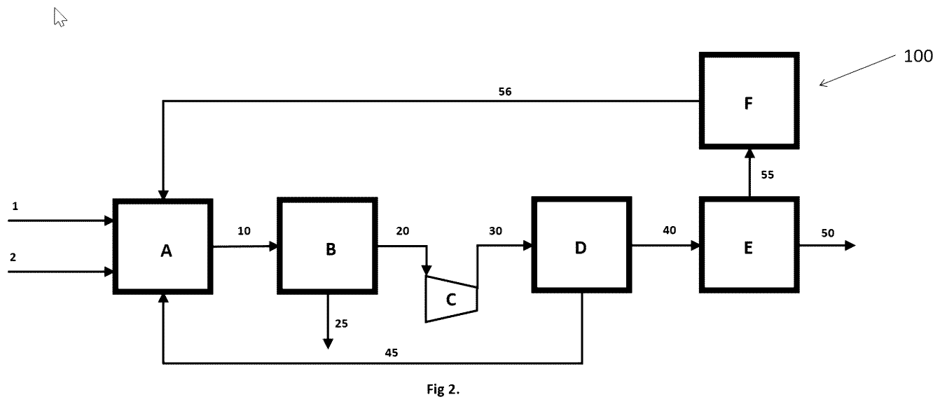

FIG. 2 shows an embodiment of the invention based on a plant identical to the plant shown in FIG. 1 with the same denominations, wherein the CO2 depleted syngas 40 is fed to a synthesis stage E, such as a Fischer-Tropsch (F-T) section and a synfuel synthesis section. From the synthesis stage E, a synfuel stream 50 is discharged and an F-T off-gas 55 is discharged and fed to an off-gas pre-treatment section F, wherein the off-gas 55 is pre-treated before being recycled to the RWGS section.

### EXAMPLE

Syngas plant designs for three cases were compared with respect to power consumption of the compressors required for operation.

Case 1: No CO2 removal is carried out. The CO2 feed flow is adjusted to obtain a H2/CO2 ratio of 1.22 in the syngas product stream. A compressor is used to increase the pressure of the syngas product stream. The syngas product has a high level of CO2, which is undesirable for many downstream synthesis processes.

Case 2: Similar to Case 1 but with a conventional amine-based CO2 removal from a part of the product syngas stream. A first compressor is used to increase the pressure of the syngas product stream after the amine-based CO2 removal. A second compressor is used to increase the pressure of the recycled CO2.

Case 3: Similar to Case 1 but with a water removal section and a cryogenic CO2 separation section. A compressor is present between the water removal section and the cryogenic CO2 separation section to compress the dehydrated syngas stream. No separate compressor for the CO2 recycle is required.

Parameters of operation and power consumption for Cases 1.3 are given in Table 1

TABLE 1

| Parameter | Unit | Case 1 | Case 2 | Case 3 |
|---|---|---|---|---|
| H2 and CO2 feed pressure | barg | 20 | 20 | 20 |
| H2 feed flow | Nm3/m | 1500 | 1500 | 1500 |
| CO2 feed flow | Nm3/m | 1000 | 808 | 807 |
| CO2 in eRWGS outlet | Dry mol % | 18.05 | 18.03 | 18.00 |
| CO2 in syngas product | Dry mol % | 18.02 | 8.34 | 8.35 |
| Syngas product pressure | Barg | 40 | 40 | 40 |
| H2/CO2 ratio in syngas | | 1.22 | 1.22 | 1.22 |
| product | | | | |
| No. of compressors | | 1 | 2 | 1 |
| Power consumption in | | | | |
| compressors | | | | |
| Syngas Product compression | kW | 74 | 74 | 91.8 |
| Recycling of CO2 | kW | 0 | 20.8 | 0 |
| Total power for compressors | kW | 74 | 94.8 | 91.8 |

As will appear from Table 1, the power consumption for the compressors required for operation of the plant is lower in Case 3 (plant according to the present invention) than in Case 2 (conventional plant). Also, Case 3 has provided the possibility of avoiding a compressor in the recycling of CO2 to the RWGS section, hence saving CAPEX and OPEX costs.

1. A plant comprising
a reverse water gas shift (RWGS) section comprising
a first feed comprising hydrogen to the RWGS section, and a second feed comprising carbon dioxide to the RWGS section, or
a combined feed comprising hydrogen and carbon dioxide to the RWGS section,
a water removal section downstream the RWGS section,
a compressor downstream the water removal section, and
a cryogenic CO2 separation section downstream the compressor,
wherein said RWGS section is arranged to convert said first feed and said second feed—or said combined feed—into a first syngas stream, and feed the first syngas stream to the water removal section,
wherein said water removal section is arranged to remove water from the first syngas stream to produce a dehydrated syngas stream and a water condensate,
wherein the compressor is arranged to compress the dehydrated syngas stream to produce a compressed syngas stream,
wherein said cryogenic CO2 separation section is arranged to separate the compressed syngas stream into a CO2 depleted syngas stream and a CO2 rich condensate,
wherein the plant has means for recycling at least a portion of the CO2 rich condensate to the RWGS section or to a feed to the RWGS section, and
wherein the RWGS section is an electrically heated RWGS (e-RWGS) section.

2. A plant according to claim 1, wherein the means for recycling at least a portion of the CO2 rich condensate does not comprise a compressor for compressing the CO2 rich condensate.

3. A plant according to claim 1, wherein the water removal section is selected from the group consisting of a flash separation unit, a pressure swing adsorption (PSA) unit, a temperature swing adsorption (TSA) unit, er and a combination thereof.

4. A plant according to claim 1, wherein the cryogenic CO2 separation section comprises a cooling unit, followed by a flash separation unit, followed by a heating unit.

5. A plant according to claim 1, wherein the H2/CO ratio in said CO2 depleted syngas stream is between approximately 0.5 and 4.5.

6. A plant according to claim 1, further comprising a synthesis stage downstream the cryogenic CO2 separation section, and wherein the cryogenic CO2 separation section is arranged to feed the CO2 depleted syngas to the synthesis stage.

7. A plant according to claim 6, wherein said synthesis stage comprises a synfuel synthesis section, an alcohol synthesis section or an olefin synthesis section.

8. A plant according to claim 7, wherein said synthesis stage comprises a synfuel synthesis section, and wherein the said synthesis stage further comprises a Fischer-Tropsch (FT) section upstream the synfuel synthesis section.

9. A plant according to claim 6, which does not comprise any compressor downstream the cryogenic CO2 separation section.

10. A plant according to claim 6, wherein the first feed at least partly is provided from an electrolysis unit.

11. A plant according to claim 1, wherein the plant comprises a pre-treatment section, wherein the second feed is pre-treated to remove undesired components.

12. A plant according to claim 1, wherein said e-RWGS section comprises a structured catalyst comprising a macroscopic structure of electrically conductive material capable of catalysing both a reverse water gas shift reaction and a methanation reaction.

13. A process comprising the steps of
providing a plant as defined in any of the preceding claims,
supplying the first feed comprising hydrogen to the RWGS section, and supplying the second feed comprising carbon dioxide to the RWGS section, or supplying said combined feed comprising hydrogen and carbon dioxide to the RWGS section,
removing water from the first syngas stream in the water removal section to produce a dehydrated syngas stream and a water condensate,
compressing the dehydrated syngas stream to form a compressed syngas stream,
separating the compressed syngas stream into a CO2 depleted syngas stream and a CO2 rich condensate in the cryogenic CO2 separation section, and
recycling at least a portion of the CO2 rich condensate to the RWGS section or to a feed to the RWGS section.

14. A process according to claim 13, wherein the CO2 rich condensate is recycled to the RWGS section without being subjected to compression.

15. A process according to claim 13, wherein the CO2 depleted syngas stream is subjected to treatment in a synthesis stage downstream the cryogenic CO2 separation section.

16. A process according to claim 15, wherein the synthesis stage comprises a synfuel synthesis section, an alcohol synthesis section or an olefin synthesis section.

17. A process according to claim 16, wherein said synthesis stage comprises a synfuel synthesis section, and wherein the said synthesis stage further comprises a Fischer-Tropsch (FT) section upstream the synfuel synthesis section.

18. A process according to claim 15, wherein the CO2 depleted syngas stream is not subjected to compression.

19. A process according to claim 15, wherein said CO2 depleted syngas stream has a module of (H₂−CO₂)/(CO+CO₂) in the range from 1.8 to 2.2, and wherein the synthesis stage comprises a methanol synthesis section.

20. A process according to claim 15, wherein said synthesis stage comprises Fischer-Tropsch synthesis reactor system for crude oil and/or wax production.

21. A process according to claim 15, wherein said CO2 depleted syngas stream has a module of (CO+H₂)/(CO₂+H₂O)>7.5.

22. A process according to claim 15, wherein said CO2 depleted syngas stream has a ratio of H₂/CO<1.5.

23. A process according to claim 13, wherein both a reverse water gas shift reaction and a methanation reaction take place in the RWGS section.
